(19) United States
(12) Patent Application Publication
(10) Pub. No.: US 2016/0026700 A1
(43) Pub. Date: Jan. 28, 2016

(54) UPDATING AND SYNCHRONIZING EXISTING CASE INSTANCES IN RESPONSE TO SOLUTION DESIGN CHANGES

(71) Applicant: International Business Machines Corporation, Armonk, NY (US)

(72) Inventors: Laurent Dubois, Huntington Beach, CA (US); Huzefa A. Hakim, Laguna Hills, CA (US); David A. Hanson, Lake Forest, CA (US); Wen-Chin Hsieh, Rolling Hills Estates, CA (US); Lauren A. Mayes, Laguna Beach, CA (US)

(21) Appl. No.: 14/636,364

(22) Filed: Mar. 3, 2015

Related U.S. Application Data
(63) Continuation of application No. 14/341,769, filed on Jul. 26, 2014.

(51) Int. Cl. G06F 17/30

(52) U.S. Cl. CPC G06F 17/30575; G06F 17/30368

(57) ABSTRACT

Methods for case management in a production environment. An update to an existing case management solution running in a production environment is received. A collection of existing case instances created before the update was made to the existing case management solution is retrieved. Each case instance in the received collection of existing case instances is processed to add missing tasks to the case instance and to update a case instance structure for each case instance. Each processed case instance is saved.

### BACKGROUND

The present invention relates to case management in production systems. Case management was originally developed because certain business applications performed by knowledge workers require a great deal of flexibility, adaptability, control, and collaboration to achieve successful outcomes. Conventional Enterprise Content Management (ECM) systems and the structured control of business process management (BPM) were not sufficient to meet the requirements of these applications.

In certain industries, such as health care, insurance, and the legal profession, case management is fairly well understood. Case management, however, can be successfully applied to a broad set of business and non-business applications, such as healthcare applications, government applications, banking applications, insurance applications, etc. Doing so provides knowledge workers and businesses with the capabilities they need to achieve their objectives.

Implementing a robust and effective case management solution requires a software platform that includes a range of functions, such as content management, process management, business rules, collaboration, analytics, etc. Ideally, the case management solution should integrate seamlessly into the work environment of the case participants. The user interface must also provide flexibility and allow a high degree of collaboration among the participants. For example, the interface must allow a user to dynamically add more tasks to a case already in process. A case management solution should also provide caseworkers with the full context of the case they are working on, so they can make better-informed decisions.

Typically, the life cycle of a case management solution implies providing updates to an existing case management solution used in a production environment. When such updates occur to the existing case management solution, the changes are often not automatically applied to existing case instances. Thus, there is a need for improved case management solutions.

### SUMMARY

According to one embodiment of the present invention, techniques are provided for case management in a production environment. An update to an existing case management solution running in a production environment is received. A collection of existing case instances created before the update was made to the existing case management solution is retrieved. Each case instance in the received collection of existing case instances is processed to add missing tasks to the case instance and to update a case instance structure for each case instance. Each processed case instance is saved.

The details of one or more embodiments of the invention are set forth in the accompanying drawings and the description below. Other features and advantages of the invention will be apparent from the description and drawings, and from the claims.

### BRIEF DESCRIPTION OF THE SEVERAL VIEWS OF THE DRAWINGS

FIG. 1 shows a schematic view of a case management solution in a production environment, in accordance with one embodiment.

FIG. 2 shows a case synchronization process for automatically update case instances, in accordance with one embodiment.

Like reference symbols in the various drawings indicate like elements.

### DETAILED DESCRIPTION

### Overview

The various embodiments of the invention described herein provide mechanisms for applying granular changes to existing case instances in production systems. As the granular changes could be numerous in a large production system, this various embodiments of the invention provide an essential tool for the life cycle of a case management solution.

In one embodiment, the case synchronization mechanism compares the deployed solution information currently available in the production environment with the current case instances (which were created before the changes were applied to the solution) and updates the out-of-sync cases with the “missing” information. Granularity is provided through parameters that allow users to specify, for example, which elements on the case instances are being updated, how many elements are updated, and the ability to stop and resume the update process.

### Terminology

Case management is built around the concept of processing a case, that is, a collection of information and coordinated activities, by knowledge workers or caseworkers.

A case management solution is the application of case management technology to a particular business problem, typically in a particular domain. Case management solutions are used, for example, in scenarios such as these:
Customer complaint management where the subject is a customer
Benefit enrollment where the subject is an employee
Legal cases where the subject is a defendant
Allow processing where the subject is a citizen
Health care claim reimbursement where the subject is a patient
Credit card dispute management where the subject is a customer

A case typically has a subject, similar to the subject of a sentence or a narrative. The subject can be one of several types, for example:
A single person such as a patient, customer, employee, or taxpayer
A legal entity such as a business, church, or government
Two or more people/entities such as in legal cases (Jones v. Smith)
An event such as a fraud occurrence, a security violation, or a system outage

For any case management solution, there can be many active cases. For example, the customer complaint management solution creates a case for each customer complaint. The term case instance is sometimes used to refer to these individual cases. Each case instance is identified by a case instance ID, which is a unique identifier representing the case instance (similar to the Vehicle Identification Number (VIN) for a vehicle).

A case folder is a mechanism that allows knowledge workers to store and retrieve information that pertains to a particular case. It also tracks the tasks that are required to process the case. The case folders can be organized in a hierarchical case folder structure.

A case type definition is the design representation of a case. The case type definition specifies the tasks, the necessary document types to support the task, the task steps, and the roles that must complete those steps to solve a business problem. The case type definition also includes properties that are displayed to caseworkers when they view the case in a Case Manager Client. The case type definitions together make up the case management solution. The case type definition is used when creating an instance of a case.

Tasks for a case can be organized into groups of tasks. A group can be defined as being inclusive or exclusive. If a group is inclusive, when a task in the group is started, all the tasks in that group are also started (and required to complete in order to complete/close the case). If a group is exclusive, when a task in that group is started, all the other tasks are cancelled and cannot be started.

### Schematic View of Case Management Solution in a Production Environment

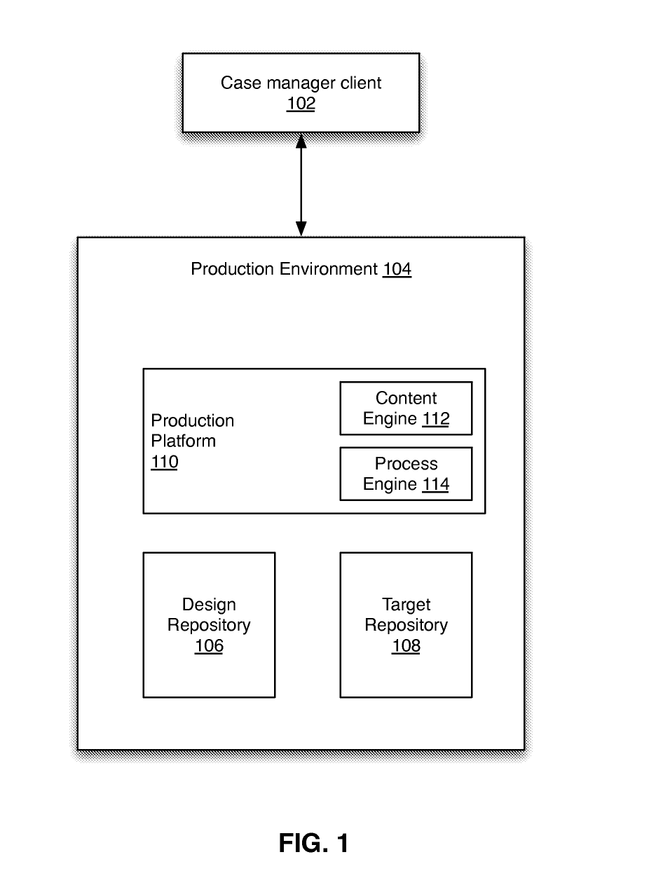

FIG. 1 shows a schematic view of a case management solution (100) in a production environment, in accordance with one embodiment. As can be seen in FIG. 1, the case management solution (100) includes a case manager client (102), and a production environment (104). The production environment (104) includes a design repository (106), a target repository (108), and a production platform (110). The production platform (110) includes a content engine (112) and a process engine (114).

The case manager client (102) is a client application that case workers use to interact with the production environment (104), for example, to create and process cases and to collaborate with others. In some embodiments, the case manager client (102) can also allow business analysts or Information Technology (IT) professionals to create customized page layouts for cases and work items to provide caseworkers with all information they need to make an informed decision as quickly as possible.

The production environment (104) is where the case management solution is deployed, run, and managed. The design repository (106) maintains files relating to the design of the case management solution. The target repository (108) maintains the deployed objects of the solution, such as case instances, task objects, and case documents. The case manager client (102) interacts with the target repository (108) to create and process cases in the solution.

The production platform (110) can be an Enterprise Content Management (ECM) platform. An ECM platform is a computer system that enables an enterprise to manage the content important to the enterprise. The content managed by the ECM platform can take the form of documents used in Microsoft Office applications, image files, etc. The content is managed in ways such as organizing documents in folders, controlling access to and versioning of those documents, etc. The ECM platform also controls work processes related to that content, such as routing work requests between various steps in a business process. One example of an ECM platform is the FileNet P8 platform, available from International Business Machines Corporation of Armonk, N.Y. The content engine (112), which is part of the production platform (110), is used to maintain the design repository (106) and the target repository (108) and to provide support for the documents, folders, annotations, and pages that are needed to process a case solution.

The process engine (114), which is also part of the production platform (110), is used to process work items for tasks that are associated with a case instance. This process includes, for example, provisioning roles and corresponding in-baskets that contain the workflow steps to be completed by caseworkers. The process engine (114) also provides the capability to retrieve, manipulate, and update case instance properties during the execution of work items.

### Exemplary Case Management Process

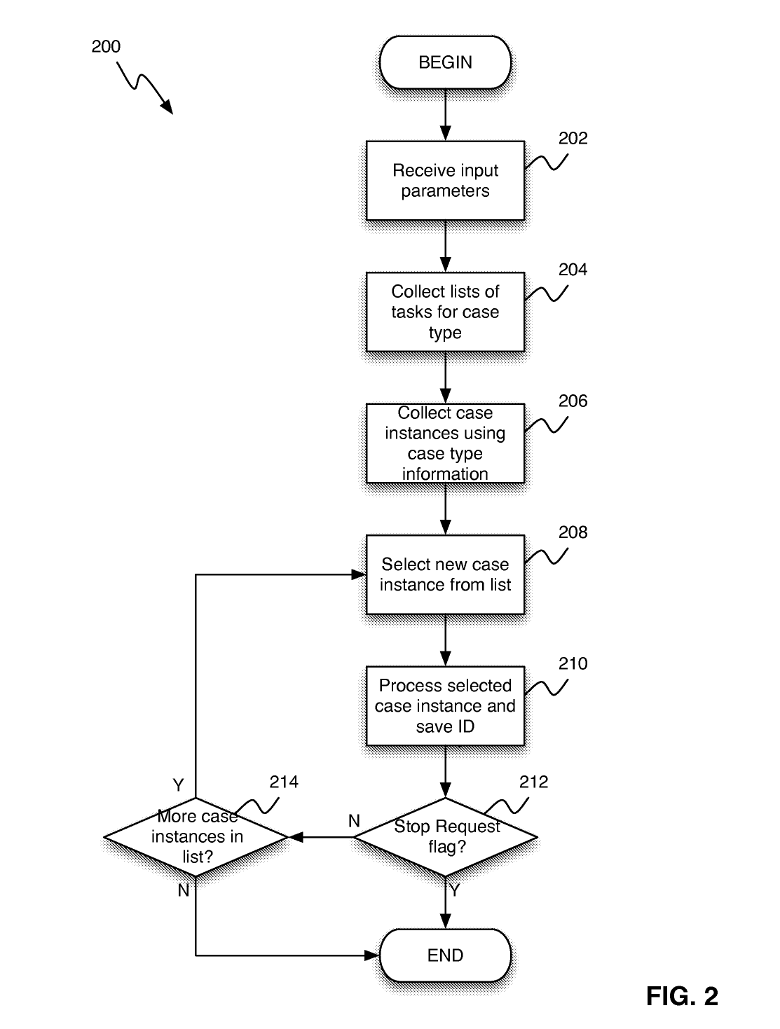

As was described above, a case management solution is deployed to a production environment (104) where users can start creating case instances based on their business activities. After a period of time, the case management solution administrator makes an update to the existing case management solution. Between the original deployment of the case management solution and the update to the case management solution, thousands of cases instances may have been created. Some of these case instances will be affected by the change to the case management solution and will thus need to be updated. FIG. 2 shows a case synchronization process (200), in accordance with one embodiment, for providing a way to automatically update these case instances. For example, assume a mortgage company that is updating its policy or governance mandate. The new policy requires that any loan case that is not yet completed with a loan amount greater than $500,000 needs an extra review/approval process. The case synchronizer will be used to update any case matching the criteria (i.e., case not completed, and loan amount greater than $500,000) and will inject the new task to be launched for the extra review/approval process, and therefore comply with the new company policy/governance mandate.

As can be seen in FIG. 2, the process (200) starts by receiving a set of input parameters (step 202). Typically the user that invokes the case synchronization tool (which is usually the solution administrator) provides the input parameters as arguments to the case synchronization tool. As will be described in further detail below, the input parameters are used in connecting to the production environment, getting a collection of existing case instances that were created before the last modified date of the case type definition for the case management solution, optionally including/excluding case instance elements from being updated, and optionally filtering out case instances based on additional search criteria.

Next, the case type information received in the input parameters is used to collect the list of tasks associated with the case (step 204). Typically, these tasks are defined at case management solution design time when defining the case. In some embodiments, optionally, the list of tasks can be further reduced by using the received include/exclude task parameters. For example, a user may only want to update a specific type of task as part of the current case synchronization, while other new task types do not make sense for existing case types. This provides some flexibility to the solution administrator doing the case synchronization.

After collecting the list of tasks, the process uses the case type information provided in the input parameters to gather case instances (step 206). In one embodiment, case instances are gathered that match the following conditions:
the case instance was created before the last modified date of the case type definition file (that is, the case instance was created before the changes were applied to the case management solution); and
any other filtering conditions passed as parameters to further narrow down the set of case instances to update.

Once the collection of case instances is gathered, one of the case instances is selected (step 208). The selected case instance is then processed to:
add missing tasks (based on the task collection retrieved in step 204 and the current tasks defined on the case instance), taking into account any grouping membership (inclusive/exclusive) configuration; and
update case instance structure in the target repository (e.g., create missing folders based on the case type definition and the current case instance folder structure)

The mechanism will save the processed case instance ID. Next, the process checks whether there is a stop request flag (step 212). The stop request flag is part of the stop/resume feature. When the case synchronization tool user requests the tool to stop synchronizing the cases, a stop request flag is created. If there is a stop request flag, the process (200) ends. Next time the mechanism is launched, it will resume from the last processed case instance.

If there is no stop request flag detected in step 212, the process (200) checks whether there are any more case instances to be processed in the list (step 214). If there are no more case instances to be processed, the process (200) ends. If there are more case instances to be processed, the process returns to step 208 and selects a new case from the case instance list, and proceeds as described above. Thus, by running the case synchronization process (200), it can be ensured that all case instances that are affected by an update to the case management solution are properly processed.

### Concluding Implementation Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for case management in a production environment, comprising:
receiving an update to an existing case management solution running in a production environment;
retrieving a collection of existing case instances created before the update was made to the existing case management solution;
processing each case instance in the received collection of existing case instances to add missing tasks to the case instance and to update a case instance structure for each case instance; and
saving each processed case instance.

2. The method of claim 1, further comprising:
receiving one or more parameters; and
using the received parameters as selection criteria when retrieving the collection of existing case instances.

3. The method of claim 1, wherein the parameters include one or more of: case type information, a list of tasks for each case type, tasks to include, tasks to exclude, parameters for connecting to the production environment, parameters for controlling the number of cases to process, and parameters for specifying a filter to narrow down the list of case instance to synchronize.

4. The method of claim 3, further comprising:
retrieving a list of tasks defined for a case type received as a parameter.

5. The method of claim 4, further comprising:
using one or more of the include tasks and the exclude tasks parameters to filter the list of tasks.

6. The method of claim 2, further comprising:
filtering the retrieved collection of existing case instances based on one or more of the received parameters to reduce the set of case instances to update.
